(19) United States
(12) Patent Application Publication
(10) Pub. No.: US 2024/0428307 A1
(43) Pub. Date: Dec. 26, 2024

(54) Live Video-Based Online Selling

(71) Applicant: Lana Mya Eitel, Lantana, FL (US)

(72) Inventor: Lana Mya Eitel, Lantana, FL (US)

(21) Appl. No.: 17/899,466

(22) Filed: Aug. 30, 2022

(51) Int. Cl. G06Q 30/0601; G06Q 20/42

(52) U.S. Cl. CPC G06Q 30/0611; G06Q 20/42; G06Q 30/0641

(57) ABSTRACT

A system and method for providing a live video-based online selling platform according to the present invention includes a live video-based online selling system configured to communicatively interconnect a seller web connection system, a connection server, and one or more buyer computing devices. The seller web connection system includes: a memory having instructions stored thereon and a processor configured to execute the instructions on the memory to cause the seller web connection system to log onto the seller web connection system, receive search queries for available items from one of one or more buyer computing devices, receive an indication of a selected item by the buyer, establish a video sales session between the seller web connection system and one of the one or more buyer computing devices, receive a buyer offer from the one of one or more buyer computing devices for the selected item, accepting the buyer offer, verify payment being transferred to a funds account of the seller from the buyer payment account, and generate shipping information for use to delivering the selected item to a shipping address associated with the buyer.

### TECHNICAL FIELD

This application relates in general to a system and method for providing an e-commerce product or service, and more specifically, to a system and method for providing a live video-based online selling platform.

### BACKGROUND

E-commerce and online selling of products has become a significant part of the economy for many, if not most, buyers of these products. The experience of locating and purchasing a desired item requires a buyer to navigate through a listing of available products on a website before selecting, purchasing, and paying for the item. These websites typically present static pages to display the available products. A buyer reviews a written description of the product which may be accompanied by photographs, specifications, reviews, and alternative products. Even with all of this information, buyers may not have all of the information needed to determine if the particular item will satisfy his/her needs. The buyer may be provided with a mechanism to send a written message to a seller with one or more questions. The buyer then waits an unspecified amount of time for the seller to respond before an informed decision may be made. Even with this exchange of messages, buyers may not fully comprehend all of the needed information because of a mismatch in terminology and related miscommunications with the request and response. The deficiencies in a static system may lengthen the time before an informed decision can be made or the buyer may be forced to make a decision without all relevant information with a chance that the product does not satisfy the needs of the buyer until the item has been purchased and shipped from the seller to the buyer.

Therefore, a need exists for a system and method for providing a live video-based online selling platform. The present invention attempts to address the limitations and deficiencies in prior solutions according to the principles and example embodiments disclosed herein.

### SUMMARY

In accordance with the present invention, the above and other problems are solved by providing a system and method for a live video-based online selling platform according to the principles and example embodiments disclosed herein.

In one embodiment, the present invention is a system for providing a live video-based online selling platform having a live video-based online selling system configured to communicatively interconnect a seller web connection system, a connection server, and one or more buyer computing devices. The seller web connection system includes: a memory having instructions stored thereon and a processor configured to execute the instructions on the memory to cause the seller web connection system to log onto the seller web connection system, receive search queries for available items from one of one or more buyer computing devices, receive an indication of a selected item by the buyer, establish a video sales session between the seller web connection system and one of the one or more buyer computing devices, receive a buyer offer from the one of one or more buyer computing devices for the selected item, accepting the buyer offer, verify payment being transferred to a funds account of the seller from the buyer payment account, and generate shipping information for use to delivering the selected item to a shipping address associated with the buyer.

According to another aspect of the present invention, the video sales session between the buyer and the seller includes additional buyers of items available from the seller.

According to another aspect of the present invention, the additional buyers may observe the session between the buyer and the seller.

According to another aspect of the present invention, the additional buyers may participate the session between the buyer and the seller.

According to another aspect of the present invention, the video sales session comprises a first video stream and a seller audio stream from the seller web connection system to the one or more buyer computing devices.

According to another aspect of the present invention, the video sales session further comprises a buyer video stream and a buyer audio stream from the one or more buyer computing devices to the seller web connection system.

According to another aspect of the present invention, the video sales session further comprises a second video stream from the seller web connection system to the one or more buyer computing devices displaying the selected item.

According to another aspect of the present invention, the video sales session comprises a scheduled time slot associated with the buyer.

In one embodiment, the present invention is a method for providing a live video-based online selling platform having a live video-based online selling system configured to communicatively interconnect a seller web connection system, a connection server, and one or more buyer computing devices. The method causing the seller web connection system to log onto the seller web connection system, receive search queries for available items from one of one or more buyer computing devices, receive an indication of a selected item by the buyer, establish a video sales session between the seller web connection system and one of the one or more buyer computing devices, receive a buyer offer from the one of one or more buyer computing devices for the selected item, accepting the buyer offer, verify payment being transferred to a funds account of the seller from the buyer payment account, and generate shipping information for use to delivering the selected item to a shipping address associated with the buyer.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system and method for providing a live video-based online selling platform according to the present invention.

FIG. 2 illustrates operation of the system and method for providing a live video-based online selling platform according to the present invention.

FIG. 3 illustrates control components within a seller client computing device within a system and method for providing a live video-based online selling platform according to the present invention.

FIG. 4 illustrates control components within a buyer client computing device within a system and method for providing a live video-based online selling platform according to the present invention.

FIG. 5 illustrates a flowchart corresponding to a method performed by software components of a system and method for providing a live video-based online selling platform according to the present invention.

FIG. 6 illustrates a generalized schematic of a programmable processing system utilized as the various computing components described herein used to implement an embodiment of the present invention.

### DETAILED DESCRIPTION

This application relates in general to a system and method for providing an e-commerce product or service, and more specifically, to a system and method for providing a live video-based online selling platform according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual” and “user” refer to an entity, e.g., a human, using a system and method for providing a live video-based online selling platform according to the present invention. The term user herein refers to one or more users.

The term “invention” or “present invention” refers to the invention being applied for via the patent application with the title “Live Video-Based Online Selling.” Invention may be used interchangeably with system.

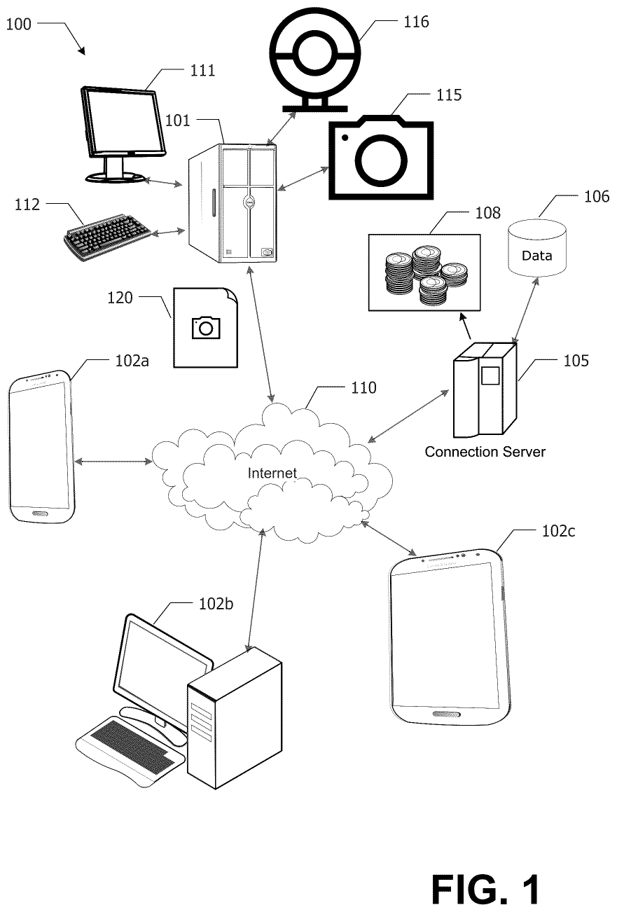

In general, the present disclosure relates to a system and method for providing a live video-based online selling platform according to the present invention. To better understand the present invention, FIG. 1 illustrates an example embodiment of a system and method for providing a live video-based online selling platform according to the present invention. A live video-based online selling platform addresses the deficiencies in existing solutions by providing an ability for a buyer and seller to communicate and interact using a live video system in which the seller may describe the products, show the products, illustrate the uses and benefits of the products, and address any questions raised by the buyer. The interaction between the buyer and seller may last as long as the individuals choose to remain connected. Negotiation over price, shipping costs and arrangements, and related topics needed to complete a transaction also may be addressed immediately. Once an agreement to complete a transaction has been reached, the buyer and seller exchange information associated with payment and shipping using computing clients running on their respective computing devices 101 and 102a-c. The seller completes the transaction by packing and shipping the purchased item to the buyer via a chosen carrier to a provided delivery address.

In one embodiment, the A live video-based online selling platform 100 may handle the exchange of payments between the buyer and seller with the funds held in escrow until successful delivery of the purchased item has been completed. At this point in time, the A live video-based online selling platform 100 releases the funds, less any service fees, to the seller. In an alternate embodiment, the transfer of funds from the buyer to the seller may occur directly using online payment services and credit card processing services. In the alternate embodiment, the A live video-based online selling platform 100 may offer a choice between acting as an intermediary for a specified fee, $9.95 a transaction, with corresponding assurances of satisfactory delivery of a purchased item, in which no fee is charged the buyer and/or seller if the payment is handled directly without any assurances of satisfaction for either party.

The system providing a live video-based online selling platform 100 comprises a seller web connection system 101, one or more buyer computing devices 102a-c, including smartphones 102a, personal computers/laptops 102b, and mobile tablet 102c devices, and a video session connection server 105.

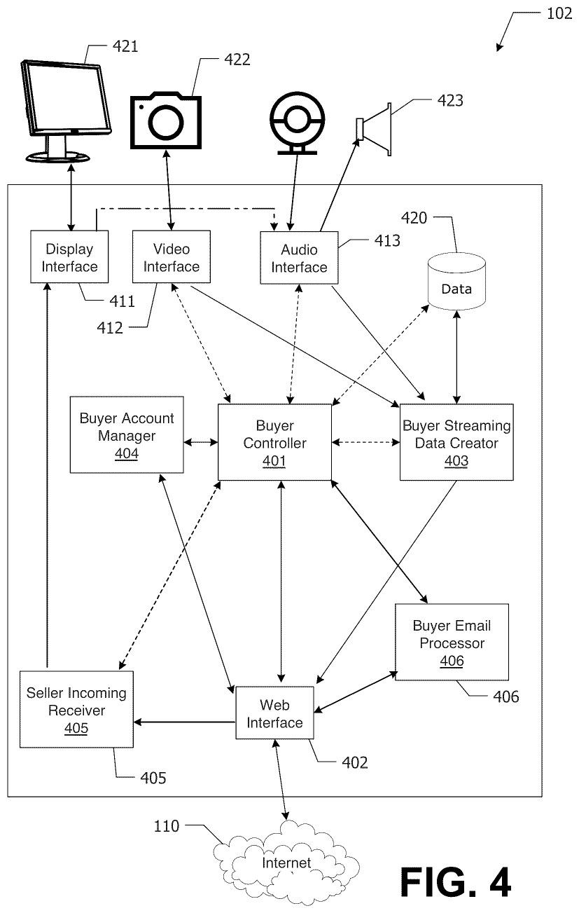

The one or more buyer computing devices 102a-c executes a mobile application running on a smartphones 102a, a personal computer/laptop 102b, and mobile tablet device 102c, to create a video session connection and accept the video streams 120 from the seller for viewing. Additional details regarding the buyer's computing device is disclosed below in reference to FIG. 4.

The video session connection server 105 provides a mechanism for the buyers 102a-c and the seller web connection system 101 to establish a video session connection. In one embodiment, the buyer and seller devices exchange IP addresses that are used by applications on the respective computing devices to establish a video session. Once established, all communications may proceed between the buyer and seller computing devices without further need for video session connection server 105 interaction. The video session connection server 105 also may provide item listing web pages, search functions, and browsing capabilities for buyers to identify items of interest. The video session connection server 105 includes a user account manager that permits buyers and sellers to access the system providing a live video-based online selling platform 100 after registering their respective identities. A video session may only be established between registered buyers and sellers for security purposes.

The video session connection server 105 also may provide payment/escrow services for the buyers and sellers. In a preferred embodiment, payment for items sold may be made to an escrow account associated with the video session connection server 105. The video session connection server 105 provides verification of receipt of the payment from the buyer. The seller may ship the purchased item to the buyer while providing the video session connection server 105 and the one or more buyer computing devices 102a-c with package tracking information associated with the shipment of the purchased goods. After delivery, the tracking number permits all of the buyer/seller and the video session connection server 105 to determine when the package has been delivered to the buyer's shipping address. The detection of this delivery may initiate the release of the funds held in escrow to the seller's bank account. The video session connection server 105 may deduct fees for providing these services from funds provided to the seller.

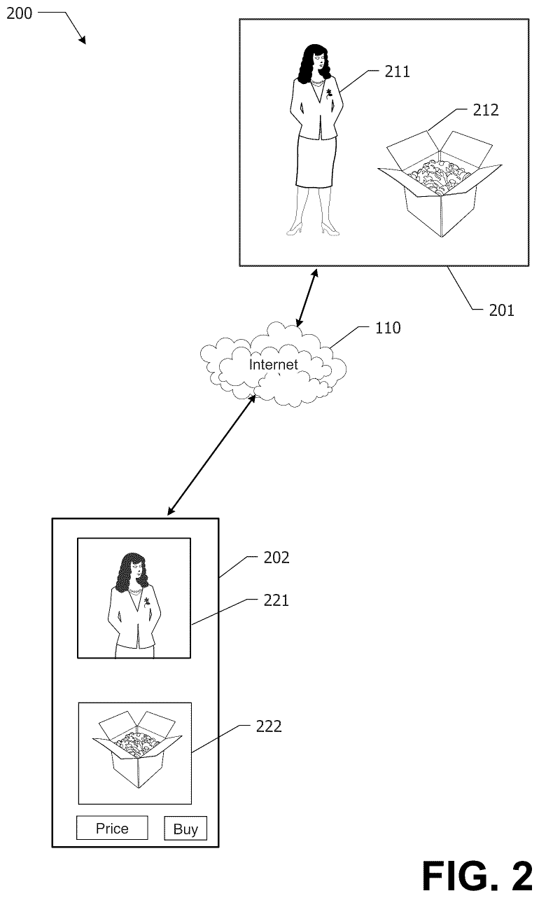

FIG. 2 illustrates operation of the system and method for providing a live video-based online selling platform according to the present invention. A description of the product is shared in the live video, negotiation of the sale occurs in this video call, and then payment and shipping can occur as most e-commerce sites do it. Information is shared by the seller to interest the buyer in viewing an item. In one embodiment, the seller 211 presents a “store” 201 as a website presenting a video call and the type of items 212 available for purchase are provided interactively by the seller 211. In this embodiment, the store 201 does not provide item descriptions on the site 201 for review before an interactive store interaction occurs.

In this first embodiment, the buyer 102a and seller 211 may conduct a private call 201-202 in which they are the only participants. The buyer 102a and seller 211 could have a conversation in which other potential buyers 102b-c can “watch and listen” until they are selected to be the active buyer, or the seller 211 can have a “room” in which multiple buyers 102a-c may enter and all people in the room may participate in a discussion. A seller web connection system 101 may provide the seller 211 a control user interface 203 to control the configuration and roles of the various buyers 102a-c. The seller 211 also is able to mute and/or kick out a particular buyer 102b if he/she is not acting appropriately.

The buyers 102a-c may view the seller's store 201 on various computing devices including smartphones 102a, personal computers/laptops 102b, and mobile tablet 102c devices. These devices require a display and user input device, which may be a touch screen device, a video camera, a microphone, and speakers as disclosed below in reference to FIG. 4. In one embodiment, the seller user controls 203 may allow the seller 211 to combine multiple video streams 221-222 into a single stream 202 (one for viewing the seller for the interaction and one directed at an item or group of items). The seller web connection system 101 may also comprise video stream design tools to create unique presentations of the items, descriptions, presentations, and the like so that the seller provides an enticing selling environment for 212 items depending upon how much control and effort he/she desires or chooses to use. These unique presentations also may include a mechanism for the sellers to present branding information directly into the video streams 202, 221-222 in which the particular branding may be associated with the items or types/groups of items.

The seller web connection system 101 provides an online scheduler 204 that permits a seller 211 to accept appointments for discussions with various potential buyers 102a-c. The seller web connection system 101 may create a queue and let buyers 102a-c into the store 201 one at a time. The seller web connection system 101 also may provide an online mechanism 204 to schedule a time to discuss an available item or type of item. This scheduler 204 may depend on how available items are listed and described enabling them to be found by buyers 102a-c. The seller 211 may accept appointments and may list categories for certain ranges of appointments. This use of different categories may allow a seller to schedule multiple potential buyers 102a-c for the same time for a limited type of item that would be relevant so that buyers listening to an interaction with other buyers might still be of interest.

The seller web connection system 101 may have different ways to transition from a current buyer to a scheduled appointment. For example, the seller web connection system 101 may provide notice to the seller 211 of an appointment and arrival of the scheduled buyer. The seller 211 then may manually control a transition from one active buyer to another. The seller web connection system 101 also may provide more interactive mechanisms that guide the transition to occur when the buyer is either a preferred buyer (from past interactions or past purchase history on the platform) or a priority item that has a higher price or margin that would be worth more of the seller's time and effort over other smaller or less expensive items. The type of appointment, category of items, date, time, and related characteristics may be specified in the scheduler 204 in which some or all of the characteristics of an appointment are visible to buyers.

In some embodiments, a seller web connection system 101 may provide listings of items (not shown) in which the details of items and suggested pricing can be shared to entice buyers' interest. This listing may include a search function that uses keywords and categories. The listing also may provide a browsing available items function to allow buyers to identify items of interest. The listings may permit a buyer 102a-c to obtain access to the scheduler 204 to find an available time and to make an appointment to interact with the seller 211.

The buyer 102a-c may buy a particular item during the live interaction with the seller 211. A buy button 223 may be included in the video stream 202 that includes a hyperlink that activates a purchase item screen in which the buyer 102a-c provides payment and shipping information to the video session connection server 105 for forwarding to the seller web connection system 101. Once the buyer completes the purchasing process, payment may be transferred video session connection server 105 escrow account 108. The funds may be release to the to the seller's account once delivery of the purchased item has occurred. Information provided by the video session connection server 105 to the seller web connection system 101 may be used in packing and shipping the purchased item to the buyer 102a-c.

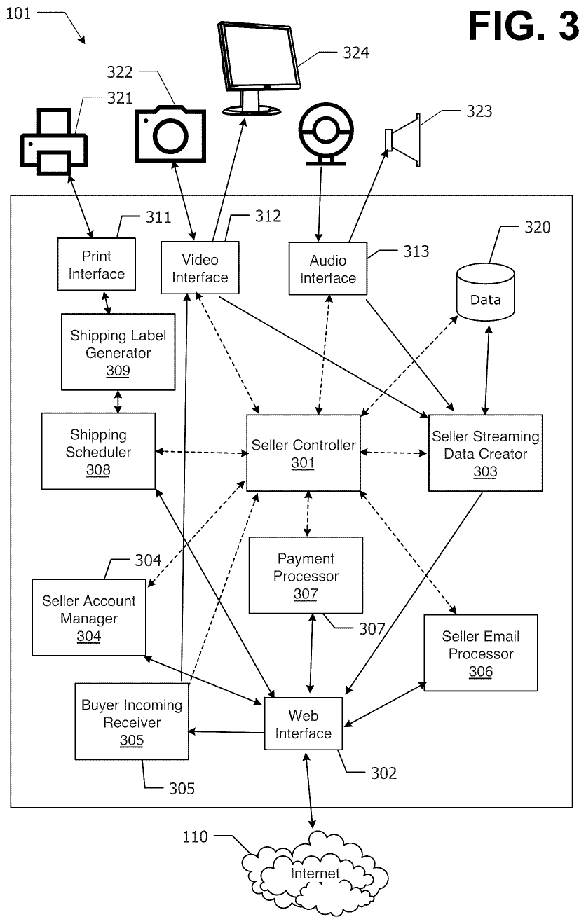

FIG. 3 illustrates control components within a seller client computing device within a system and method for providing a live video-based online selling platform according to the present invention. The seller web connection system 101 comprises a set of computing components that perform functions needed to support a seller in a video connection. The set of computing components comprises a seller controller 301, a seller web interface 302, a seller streaming data creator 303, a seller account manager 304, a buyer incoming receiver 305, a seller message processor 306, a payment processor 307, a shipping scheduler 308, a shipping label generator 309, a print interface 311 coupled to a printer 321, a seller video interface 312 coupled to a display device 323 and one or more video cameras 322, and a seller audio interface 313 coupled to a microphone 324 and speaker 325.

The seller controller 301 receives buyer communication via the seller web interface 302 when it arrives from the buyer computing device 102a-c and mobile application. The seller controller 301 also verifies the buyer is a registered user, initiates a video session with one or more of the buyer computing devices 102a-c and mobile applications, and exchanges messages with the buyer computing device 102a-c and mobile application via the seller message processor 306. The seller controller 301 receives payment and shipping information from the buyer computing device 102a-c and mobile application, processes payment for an item to be purchased via the payment processor 307, schedules shipment of the purchased item after payment has been successfully processed via the shipping scheduler 308, and then generates a shipping label for the item to be shipped to the buyer. When all steps are completed, an acknowledgement message or an error message based upon the above steps is generated and sent by the seller controller 301 to the buyer. The generated message is sent to the buyer computing device 102a-c and mobile application via the seller web interface 302.

The seller web interface 302 permits the seller web connection system 101 to communicate with the buyer computing device 102a-c and mobile application and the connection server 105. The seller web interface 302 performs all of the data formatting, computer-to-computer communications, encryption processing, and all similar operations needed by the web server to communicate with users.

The seller streaming data creator 303 accepts input audio and video data from the seller video interface 312 coupled to one or more video cameras 322, and a seller audio interface 313 coupled to the microphone 324 to format and generate an outgoing video stream for a video connection to the buyer computing device 102a-c and mobile application. A combination of multiple video and audio data streams into a format defined by the seller, including any branding and category identification information, is performed by the seller streaming data creator 303 as the outgoing video stream is generated. The outgoing video stream is transmitted via the seller web interface 302 to the buyer computing device 102a-c and mobile application over the Internet 110.

The seller account manager 304 permits the seller web connection system 101 to connect to and access the connection server 105. The seller account manager 304 is responsible for creating and managing user accounts for the sellers 211. The seller account manager 304 also is used in authenticating a seller based upon user input. Typically, the seller input uses a username and password. Multi-factor authentication, use of one-time passwords, and similar secure authentication mechanisms may be included in the seller profile. For every sign-in, the seller web connection system 101 recognizes the seller 211, along with all past activities from seller account details in the connection server 105. The seller account manager 304 also verifies the buyer identity with the connection server 105 in order to authenticate a buyer for an item and the associated payment and shipping information.

The buyer incoming receiver 305 accepts the incoming video connection from the buyer computing device 102a-c and mobile application over the Internet 110 via the seller web interface 302. The buyer incoming receiver 305 processes the incoming video connection and sends the corresponding audio data to the seller audio interface 313 and the seller video interface 312 for consumption by the seller.

The seller message processor 306 generates and transmits all non-video and audio connection data that is exchanged between the buyer computing device 102a-c and mobile application and the seller web connection system 101 over the Internet 110. The seller message processor 306 exchanges messages to create a video connection between the buyer computing device 102a-c and mobile application and the seller web connection system 101 by exchanging IP addresses and related communications. The seller message processor 306 also transmits a confirmation and/or an error message associated with processing a request for purchase of an item. The seller message processor 306 also may create and send email messages to the buyer for off-line communications.

The payment processor 307 receives payment information associated with a buyer to obtain payment for purchase of an item. The payment information may comprise credit card information, e-check account and routing numbers, and other payment service account information associated with third party payment services such as PayPal™ and ApplePay™. The payment processor 307 receives the price of the item being purchased and the above payment information to transmit a payment request from a corresponding payment processor or bank requesting transfer of the purchase price from the identified buyer account to a bank account associated with the video session connection server 105. The payment processor 307 receives confirmation of the successful transfer of the funds before shipping may occur.

The shipping scheduler 308 accepts item information defining the item to be shipped, the shipping time being requested, and any cost requirements for the shipment. The shipping scheduler 308 includes the size, weight, and contents of the item to be shipped. The shipping scheduler 308 determines which available shipping carrier may be used to satisfy the shipping requirements, time, and cost requests and communicates with remote shipper servers (not shown) to schedule a corresponding shipment. The shipping scheduler 308 may obtain a routing number, a pickup or delivery address for the seller to use to ship the item, and any other relevant information (such as hazardous handling and labeling requirements). The shipping scheduler 308 sends all of the shipping information to the shipping label generator 309 to print a label to be used when the item is packed for shipment.

The shipping label generator 309 accepts shipping information, which may include identification of a purchased item and a corresponding buyer shipping address and generates a shipping label to be printed on a printer 321 via the printer interface 311. The shipping label generator 309 receives the shipping information from the shipping scheduler 308 along with an identity of a shipping carrier to be used for shipment of a purchased item to generate a shipping label for the selected shipping carrier at a desired delivery date.

The print interface 311 coupled to a printer 321 provides a device driver permitting the seller web connection system 101 to print shipping labels created by the shipping label generator 309. The print interface 311 is responsible for all communications between the seller web connection system 101 and the printer 321, whether connected directly or via a network connection. The print interface 311 also is responsible for converting print data specified in a common format, for example a PDF format, to match any specific printing functions associated with the attached printer 321.

The seller video interface 312 coupled to a display device 323 and one or more video cameras 322 provides input and output interfaces to obtain one or more video streams from the one or more video cameras 322 to be used by the seller streaming data creator 303 to generate a video stream for a video connection with a buyer. The video interface 312 also provides output connections to the display device 323 to permit the seller to view any incoming video streams from one or more buyers in addition to the sellers outgoing video stream for the seller's viewing.

The seller audio interface 313 is coupled to a microphone 324 and speaker 325 to accept audio data from the microphone 324 for use by the seller streaming data creator 303 to generate a video stream for an audio connection with a buyer. The seller audio interface 313 also outputs audio data from a buyer computing device 102a-c and mobile application received by the buyer incoming receiver 305 to the speaker 325 for consumption by the seller during a video connection.

FIG. 4 illustrates control components within a seller client computing device within a system and method for providing a live video-based online selling platform according to the present invention. The buyer computing device 102a-c and mobile application comprises a set of computing components that performs functions needed to support a buyer in a video connection. The set of buyer computing components comprises a buyer controller 401, a buyer web interface 402, a buyer streaming data creator 403, a buyer account manager 404, a seller incoming receiver 405, a buyer message processor 406, a buyer display interface 411 coupled to a buyer display device 421, a buyer video interface 412 coupled a video camera 422, and a buyer audio interface 413 coupled to a microphone 424 and speaker 425.

The buyer controller 401 receives seller communication and video streams via the buyer web interface 402 when it arrives from the seller web connection system 101. The buyer controller 401 exchanges messages with the seller web connection system 101 via the buyer message processor 406. The buyer controller 401 generates payment and shipping information to be sent to the video session connection server 105, and eventually to seller web connection system 101 for an item to be purchased upon receipt of an input command from the buyer. Confirmation of a successful sale or an error message is received from the seller web connection system 101in response to the purchase request.

The buyer web interface 402 permits the buyer computing device 102a-c and mobile application to communicate with the seller web connection system 101 and the connection server 105. The buyer web interface 402 performs all of the data formatting, computer-to-computer communications, encryption processing, and all similar operations needed by the web server to communicate with users.

The buyer streaming data creator 403 accepts input audio and video data from the buyer video interface 412 coupled to one or more video cameras 422, and a buyer audio interface 413 coupled to the microphone 424 to format and generate an outgoing audio and/or video stream for a video connection to the seller web connection system 101. The video connection may provide a streaming video image of the buyer to the seller web connection system 101 depending upon the configuration of the seller's settings as well as being enabled by the buyer mobile application. The outgoing audio and/or video stream is transmitted via the buyer web interface 402 to the seller web connection system 101 over the Internet 110.

The buyer account manager 404 permits the buyer computing device 102a-c and mobile application to connect to and access the connection server 105. The buyer account manager 404 is responsible for creating and managing user accounts for the buyers 102a-c. The buyer account manager 404 also is used in authenticating a buyer based upon user input. Typically, the buyer input uses a username and password. Multi-factor authentication, use of one-time passwords, and similar secure authentication mechanisms may be included in the buyer profile. For every sign-in, the buyer computing device 102a-c and mobile application recognizes the buyer 211, along with all past activities from buyer account details in the connection server 105. The buyer account manager 404 also verifies the seller identity with the connection server 105 in order to authenticate a seller when an item is to be purchased.

The seller incoming receiver 405 accepts the incoming video connection from the seller web connection system 101 over the Internet 110 via the buyer web interface 402. The seller incoming receiver 405 processes the incoming video connection and sends the corresponding audio data to the buyer audio interface 412 and the buyer display interface 411 for consumption by the buyer.

The buyer message processor 406 generates and transmits all non-video and audio connection data that is exchanged between the buyer computing device 102a-c and mobile application and the seller web connection system 101 over the Internet 110. The buyer message processor 406 exchanges messages to create a video connection between the buyer computing device 102a-c and mobile application and the seller web connection system 101 by exchanging IP addresses and related communications. The buyer message processor 406 also transmits payment information and shipping information associated with a request for purchase of an item. The buyer message processor 406 also may create and send email messages to the seller for off-line communications.

The buyer display interface 411 coupled to a buyer display device 421 provides output connections to the display device 421 to permit the buyer to view any incoming video streams from the seller and one or more other buyers in addition to the buyer outgoing video stream for the seller's viewing.

The buyer video interface 412 coupled to a camera 422 provides an input interface to obtain one or more video streams from the video cameras 422 to be used by the buyer streaming data creator 403 to generate a video stream for a video connection with a seller.

The buyer audio interface 413 coupled to a microphone 424 and speaker 425 accepts audio data from the microphone 424 for use by the buyer streaming data creator 403 to generate a video stream for an audio connection with a seller. The buyer audio interface 413 also outputs audio data from the seller web connection system 101 received by the seller incoming receiver 405 to the speaker 425 for consumption by the buyer during a video connection.

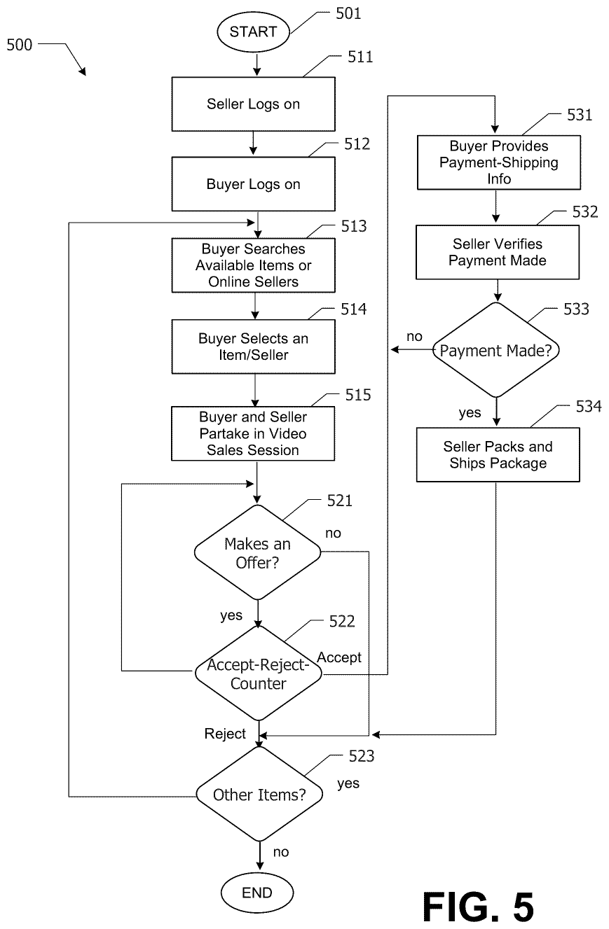

FIG. 5 illustrates a flowchart corresponding to a method performed by software components of a system and method for providing a live video-based online selling platform according to the present invention. The process 500 begins 501 when a seller logs into the seller web connection system 101 in step 511. The buyer logs into the mobile application on a buyer computing device 102a-c 101 in step 512.

The buyer searches for available items in step 513 and selects an item of interest in step 514. The buyer and seller, in step 515, establish a video connection in which the item is shown, discussed, and a price negotiated. In test step 521, the process 500 determines whether a buyer makes an offer, and if not, the process continues to test step 523; otherwise, test step 522 determines whether the offer is accepted, rejected, or a counteroffer is made. If a counteroffer is determined to have been made, the process 500 returns to step 521 to obtain the counteroffer. If the offer is rejected, the process 500 continues to test 523 to determine if other items or a continuing discussion is desired.

If an acceptance of the offer is determined to have been made, the process continues to step 531 in which the buyer provides shipping and payment information. In step 532, the video session connection server 105 processes the payment request before test step 533 determines whether payment was transferred, and if so, the item is packed for shipment in step 534 before process 500 proceeds to test step 523. If test step 533 determines that payment was not successfully transferred, the process 500 may generate an error message before proceeding to test step 523.

Test step 523, regardless of the path taken to this step, determines whether the buyer and seller are to continue the video connection. The continuation of the video connection may be to permit additional negotiations and/or discussion and presentation of other items available for purchase. When test step 523 determines that additional discussion is requested, process 500 returns to step 513 to continue the video connection; otherwise the process 500 ends 502.

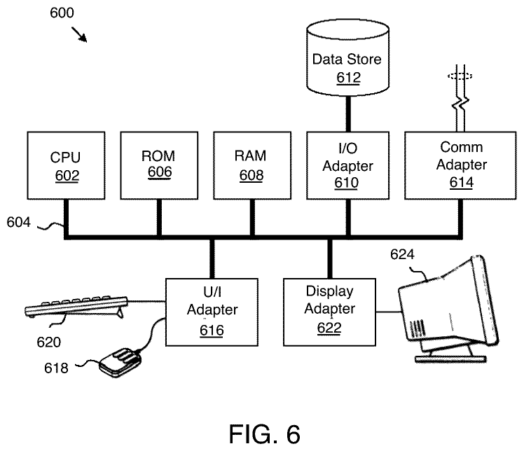

FIG. 6 illustrates a computer system 600 adapted according to certain embodiments of the server and/or the user interface device. The central processing unit (“CPU”) 602 is coupled to the system bus 604. The CPU 602 may be a general-purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 also may include read-only memory (ROM) 606 which may be PROM, EPROM, EEPROM, optical storage, or the like. The ROM 606 may store configuration information for booting the computer system 600. The RAM 608 and the ROM 606 hold user and system data, and both the RAM 508 and the ROM 606 may be randomly accessed.

The computer system 600 also may include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid-state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 110, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical and/or logical.

The applications of the present disclosure are not limited to the architecture of the computer system 600. Rather the computer system 600 is provided as an example of one type of computing device that may be adapted to perform the functions of a computing device and/or the user interface device 610. For example, any suitable processor-based device may be utilized including, without limitation, personal data assistants (PDAs), tablet computers, smartphones, computer game consoles, and multi-processor servers. Moreover, the systems and methods of the present disclosure may be implemented on application-specific integrated circuits (ASIC), very large-scale integrated (VLSI) circuits, state machine digital logic-based circuitry, or other circuitry.

The embodiments described herein are implemented as logical operations performed by a computer. The logical operations of these various embodiments of the present invention are implemented (1) as a sequence of computer-implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules. As such, persons of ordinary skill in the art may utilize any number of suitable electronic devices and similar structures capable of executing a sequence of logical operations according to the described embodiments. For example, the computer system 600 may be virtualized for access by multiple users and/or applications.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A live video-based online selling system for providing a live video-based online selling platform, the live video-based online selling system configured to communicatively interconnect a seller web connection system, a connection server, and one or more buyer computing devices, the seller web connection system comprises:
a memory having instructions stored thereon; and
a processor configured to execute the instructions on the memory to cause the electronic apparatus to:
logging onto the seller web connection system;
receiving search queries for available items from one of one or more buyer computing devices;
receiving an indication of a selected item by the buyer;
establishing a video sales session between the seller web connection system and one of the one or more buyer computing devices;
receiving a buyer offer from the one of one or more buyer computing devices for the selected item;
accepting the buyer offer;
verifying payment being transferred to a funds account of the seller from the buyer payment account; and
generating shipping information for use to delivering the selected item to a shipping address associated with the buyer.

2. The seller web connection system according to claim 1, wherein the video sales session between the buyer and the seller includes additional buyers of items available from the seller.

3. The seller web connection system according to claim 2, wherein the additional buyers may observe the session between the buyer and the seller.

4. The seller web connection system according to claim 2, wherein the additional buyers may participate the session between the buyer and the seller.

5. The seller web connection system according to claim 2, wherein the video sales session comprises a first video stream and a seller audio stream from the seller web connection system to the one or more buyer computing devices.

6. The seller web connection system according to claim 5, wherein the video sales session further comprises a buyer video stream and a buyer audio stream from the one or more buyer computing devices to the seller web connection system.

7. The seller web connection system according to claim 6, wherein the video sales session further comprises a second video stream from the seller web connection system to the one or more buyer computing devices displaying the selected item.

8. The seller web connection system according to claim 2, wherein the video sales session comprises a scheduled time slot associated with the buyer.

9. A method for providing a live video-based online selling platform, the live video-based online selling system configured to communicatively interconnect a seller web connection system, a connection server, and one or more buyer computing devices, the method comprising:
logging onto the seller web connection system;
receiving search queries for available items from one of one or more buyer computing devices;
receiving an indication of a selected item by the buyer;
establishing a video sales session between the seller web connection system and one of the one or more buyer computing devices;
receiving a buyer offer from the one of one or more buyer computing devices for the selected item;
accepting the buyer offer;
verifying payment being transferred to a funds account of the seller from the buyer payment account; and
generating shipping information for use to delivering the selected item to a shipping address associated with the buyer.

10. The method according to claim 9, wherein the video sales session between the buyer and the seller includes additional buyers of items available from the seller.

11. The method according to claim 10, wherein the video sales session comprises a first video stream, a second video stream, and a seller audio stream from the seller web connection system to the one or more buyer computing devices and a buyer video stream and a buyer audio stream from the one or more buyer computing devices to the seller web connection system.

12. The method according to claim 9, the video sales session comprises a scheduled time slot associated with the buyer.
